(19) United States
(12) Patent Application Publication
(10) Pub. No.: US 2018/0041888 A1
(43) Pub. Date: Feb. 8, 2018

(54) DEVICE-TO-DEVICE DISCOVERY

(71) Applicant: FUJITSU LIMITED, Kawasaki-shi (JP)

(72) Inventors: Chenxi ZHU, Fairfax, VA (US); Akira ITO, San Jose, CA (US)

(73) Assignee: FUJITSU LIMITED, Kawasaki-shi (JP)

(21) Appl. No.: 15/786,513

(22) Filed: Oct. 17, 2017

Related U.S. Application Data
(63) Continuation of application No. PCT/US2015/026348, filed on Apr. 17, 2015.

(51) Int. Cl. H04W 8/00; H04L 29/08; H04W 76/02; H04W 48/16

(52) U.S. Cl. CPC H04W 8/005; H04W 48/16; H04L 67/16; H04W 76/026

(57) ABSTRACT

A method of adjusting a transmission probability for device-to-device out-of-network discovery may include receiving, outside of network coverage, device-to-device discovery messages associated with a discovery resource pool. A count of idle resources, a count of resources associated with successfully received discovery messages, and a count of resources associated with discovery messages not successfully received may be detected for the discovery resource pool. A transmission probability associated with the discovery resource pool may be adjusted based at least in part on one or more of the count of idle resources, the count of resources associated with successfully received discovery messages, and the count of resources associated with discovery messages not successfully received. A device-to-device discovery message may be transmitted via the discovery resource pool based at least in part on the transmission probability.

### FIELD

The embodiments discussed herein are related to device-to-device discovery.

### BACKGROUND

Device-to-device (D2D) communication may provide for direct data transmission between wireless devices in a wireless communication network. In general, D2D communication may increase network capacity by allowing for spatial multiplexing, which may increase the reuse and sharing of wireless communication resources. Additionally, a D2D link between wireless devices may have improved channel quality as compared to a link between a wireless device and an access point of a wireless communication system. Further, the communication of data between wireless devices through D2D communication may be direct instead of being relayed by an access point, which may reduce the usage of wireless communication resources. The direct communication may also reduce delays that may be associated with relaying data through the access point.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of adjusting a transmission probability for device-to-device out-of-network discovery may include receiving, outside of network coverage, device-to-device discovery messages associated with a discovery resource pool. A count of idle resources, a count of resources associated with successfully received discovery messages, and a count of resources associated with discovery messages not successfully received may be detected for the discovery resource pool. A transmission probability associated with the discovery resource pool may be adjusted based at least in part on one or more of the count of idle resources, the count of resources associated with successfully received discovery messages, and the count of resources associated with discovery messages not successfully received. A device-to-device discovery message may be transmitted via the discovery resource pool based at least in part on the transmission probability.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram of an example wireless communication network;

FIG. 2A is a diagram of an example wireless device that may be included in the example wireless communication network of FIG. 1;

FIG. 2B is a diagram of an example layer configuration that may be implemented by the wireless device of FIG. 2A;

FIG. 3 is a flowchart of an example method of transmitting device-to-device (D2D) discovery messages and gathering information for adjusting a transmission probability for D2D discovery that may be implemented by the wireless device of FIG. 2A;

FIG. 4 is a flowchart of an example method of adjusting a transmission probability based on a tuple that may be implemented by the wireless device of FIG. 2A; and

FIG. 5 is a flowchart of an example method of adjusting a transmission probability for D2D out-of-network discovery that may be implemented by the wireless device of FIG. 2A.

### DESCRIPTION OF EMBODIMENTS

Embodiments of the present invention will be explained with reference to the accompanying drawings.

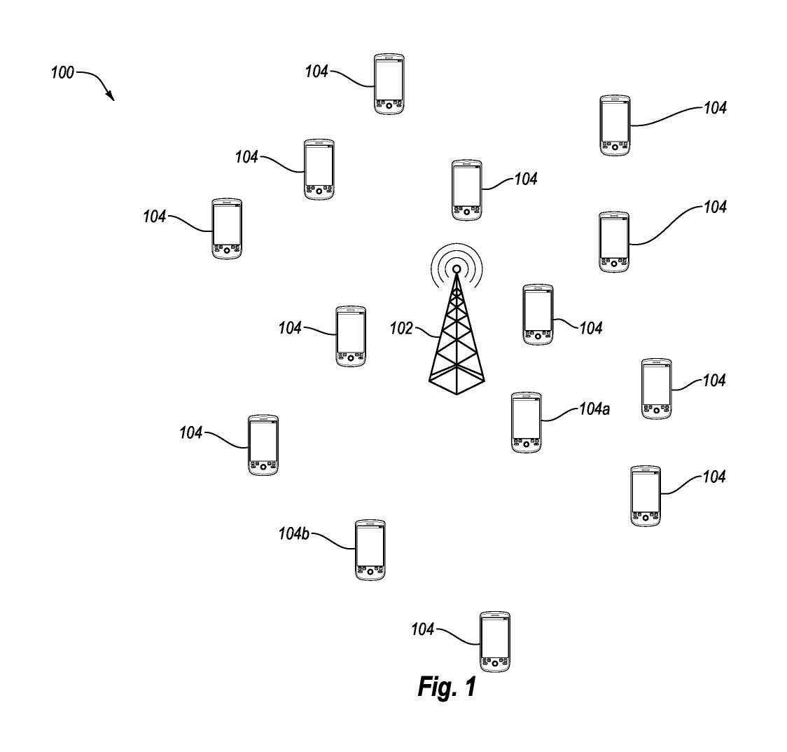

FIG. 1 is a diagram of an example wireless communication network 100. The network 100 may be configured to provide wireless communication services to one or more wireless devices 104 via one or more access points, such as an access point 102. The wireless communication services may be voice services, data services, messaging services, and/or any suitable combination thereof. The network 100 may include a Frequency Division Multiple Access (FDMA) network, an Orthogonal FDMA (OFDMA) network, a Code Division Multiple Access (CDMA) network, a Time Division Multiple Access (TDMA) network, and/or any other suitable wireless communication network. In some embodiments, the network 100 may be configured as a third generation (3G) wireless communication network and/or a fourth generation (4G) wireless communication network. In these or other embodiments, the network 100 may be configured as a long-term evolution (LTE) or LTE advanced (LTE-A) wireless communication network.

The access point 102 may be any suitable wireless communication network communication point and may include, by way of example, a base station, an evolved node B (eNB) base station, a remote radio head (RRH), or any other suitable communication point. The wireless devices 104 may include any devices that may use the network 100 for obtaining wireless communication services and may include, by way of example, a cellular phone, a smartphone, a personal data assistant (PDA), a laptop computer, a personal computer, and a tablet computer, or any other similar device.

The wireless devices 104 may be configured to perform device-to-device (D2D) communication. In some embodiments, the wireless devices 104 may be configured to perform D2D communication both with assistance from the access point 102 and without assistance from the access point 102. Performing D2D communication with assistance from the access point 102 may be described herein as “in-network” D2D communication. Performing D2D communication without assistance from the access point 102 may be described herein as “out-of-network” D2D communication. In some embodiments, in-network D2D communication may be performed while the wireless devices 104 are connected to the access point 102 and out-of-network D2D communication may be performed while the wireless devices 104 are not connected to the access point 102. For example, the wireless devices 104 may perform out-of-network D2D communication while the wireless devices 104 are outside of a communication range of the access point 102.

To perform in-network or out-of-network D2D communication, individual wireless devices 104 may discover other wireless devices 104 with which the wireless devices 104 may wirelessly communicate. For example, a first wireless device 104a may discover a second wireless device 104b.

The wireless devices 104 may discover their neighboring wireless devices 104 using various types of D2D discovery messages. For example, the first wireless device 104a may transmit a first D2D discovery message that is received and decoded by the second wireless device 104b. In these and other embodiments, the first wireless device 104a may then be known to the second wireless device 104b. The second wireless device 104b, however, may not be known to the first wireless device 104a. In these and other embodiments, the second wireless device 104b may send a second D2D discovery message to the first wireless device 104a. When the first wireless device 104a receives and decodes the second D2D discovery message from the second wireless device 104b, the second wireless device 104b may be known to the first wireless device 104a. After the first wireless device 104a and the second wireless device 104b are known to each other, they may perform D2D communication.

In some embodiments, the wireless devices 104 may transmit discovery messages on discovery resources according to a transmission probability. The discovery resources may include one or more frequencies and/or one or more time periods during which discovery messages may be transmitted by the wireless devices 104. In some embodiments, the discovery resources may be grouped into discovery resource pools. Alternately or additionally, the discovery resources may be randomly selected from the discovery resource pool.

The transmission probability may be based on a probability that discovery messages will be successfully received by other wireless devices 104. In some embodiments, discovery messages may be successfully received by wireless devices 104 if there are not collisions on the discovery resources via which the discovery messages are transmitted. Thus, for example, the transmission probability may influence the number of discovery messages transmitted and/or retransmitted by the wireless devices 104. Alternately or additionally, the transmission probability may influence a rate at which the discovery messages are transmitted and/or retransmitted by the wireless devices 104. In some embodiments, the transmission probability may be greater than 0 and less than or equal to 1. Optionally, the transmission probability values may be predefined. By way of example, possible transmission probability values may include the values 0.25, 0.5, 0.75, and 1.0. Separate transmission probabilities may be defined for separate discovery resource pools.

The transmission probability may be adjusted to control congestion and/or to improve D2D discovery resource usage. In some embodiments, reducing the transmission probability may encourage a reduction in the number and/or rate of discovery messages transmitted, which may reduce congestion. For example, reducing the transmission probability may reduce congestion when a relatively high number of wireless devices 104 are sending discovery messages. In some embodiments, increasing the transmission probability may encourage an increase in the number and/or rate of discovery messages transmitted, which may improve resource usage. For example, increasing the transmission probability may improve resource usage when a relatively low number of wireless devices 104 are sending discovery messages.

For in-network D2D communication, the access point 102 may adjust the transmission probability. For example, the access point 102 may adjust the transmission probability based on the number of wireless devices 104 indicating an intention to perform D2D discovery. The access point 102 may inform the wireless devices 104 of the transmission probability via radio resource control (RRC) signaling.

For out-of-network D2D communication, the access point 102 may not be able to configure the transmission probability for the wireless devices 104 participating in out-of-network D2D communication. In these and other embodiments, the wireless devices 104 may adjust the transmission probability for out-of-network D2D communication. In some embodiments, each of the wireless devices 104 may adjust an individual transmission probability. For example, each of the wireless devices 104 may adjust its individual transmission probability based on a count of idle resources in a discovery resource pool, a count of resources in the discovery resource pool associated with successfully received discovery messages, and/or a count of resources in the discovery resource pool associated with discovery messages not successfully received.

In some embodiments, when the wireless devices 104 move out of network coverage, the wireless devices 104 may initially base individual transmission probability values on the transmission probability received from the access point 102. While out-of-network, the wireless devices 104 may individually adjust the transmission probabilities. For example, the wireless devices 104 may adjust the transmission probabilities as described in this disclosure. In some embodiments, when the wireless devices 104 move back into network coverage, the wireless devices 104 may again use the transmission probability received from the access point 102. For example, the wireless devices 104 may update the individual transmission probabilities to reflect the transmission probability provided by the access point 102 via RRC signaling when the wireless devices 104 are in a communication range of the access point 102.

Discovery messages may not be successfully received by the wireless devices 104 due to collisions on a D2D discovery resource. For example, if two or more wireless devices 104 transmit discovery messages on the same resource, other wireless devices 104 may not successfully receive the discovery messages due to the discovery messages colliding on the resource. In some embodiments, the wireless devices 104 may detect, e.g., through energy detection or the like, that discovery messages were transmitted via a particular resource, but the wireless devices 104 detecting the discovery messages may be unsuccessful in decoding the discovery messages.

Successfully received discovery messages may include discovery messages that are detected and successfully decoded. Discovery messages may be successfully received when corresponding discovery messages are detected via a resource. A discovery message may be successfully received when it is detected via a resource. Successfully received discovery messages may generally facilitate D2D communication between two or more of the wireless devices 104.

An idle resource may include an unused resource. For example, an idle resource may include a resource via which the individual wireless devices 104 do not detect a discovery transmission and/or a discovery transmission attempt. Put another way, an idle resource may include a resource over which a discovery message may have been successfully received if a discovery message had been transmitted by one of the wireless devices 104 via the resource.

In some embodiments, the individual wireless devices 104 may monitor discovery resources while the individual wireless devices 104 are not transmitting. After monitoring each discovery resource associated with a discovery resource pool, the wireless devices 104 may adjust the transmission probability for the discovery resource pool based on the count of idle resources, the count of resources associated with successfully received discovery messages, and the count of resources associated with discovery messages not successfully received.

In some embodiments, the transmission probability may be reduced if the count of resources associated with discovery messages not successfully received is relatively high. In some embodiments, the transmission probability may be increased if the count of idle resources is relatively low.

By way of example, the wireless devices 104 may employ a tuple {N0, N1, NC}, where N0 may represent the count of idle resources, N1 may represent the count of resources associated with successfully received discovery messages, and N_{C} may represent the count of resources associated with discovery messages not successfully received. In some embodiments, the information from the tuple {N₀, N₁, N_{C}} may be employed to calculate the following expressions.

$$N = {N}_{0} + {N}_{1} + {N}_{C}$$

$${q}_{0} = \frac{{N}_{0}}{N}$$

$${q}_{C} = \frac{{N}_{C}}{N}$$

The symbol N, which may be referred to herein as total resources, may represent a total of the count of idle resources, the count of resources associated with successfully received discovery messages, and the count of resources associated with discovery messages. The symbol q0, which may be referred to herein as an idle ratio, may represent a ratio of the count of idle resources to the total resources. The symbol qC, which may be referred to herein as a collision ratio, may represent a ratio of the count of resources associated with the discovery messages not successfully received to the total resources.

In some embodiments, if the collision ratio is greater than a collision ratio threshold, which may be represented by a symbol q*C, the transmission probability may be reduced. For instance, the transmission probability may be decremented by a decrement value, which may be represented by a symbol Δp⁻. If the collision ratio is less than or equal to the collision ratio threshold and the idle ratio is greater than an idle ratio threshold, which may be represented by a symbol q^{*}₀, the transmission probability may be increased. For instance, the transmission probability may be incremented by an increment value, which may be represented by a symbol Δp⁺. Thus, for example, the transmission probability, which may be represented by a symbol p, may be adjusted according to the following pseudocode representation.

if q_{c}>q_{c}^{*}, then: p=p−Δp⁻

else, if q₀>q₀^{*}, then: p=p+Δp⁺

In some embodiments the collision ratio threshold, the decrement value, the idle ratio threshold, and/or the increment value may include a value greater than 0 and less than 1. By way of example, in some implementations the collision ratio threshold may be equal to 0.264, the decrement value may be equal to 0.005, the idle ratio threshold may be equal to 0.368, and/or the increment value may be equal to 0.0075. Alternately or additionally, the wireless devices 104 may configure and/or adjust the values of the collision ratio threshold, the decrement value, the idle ratio threshold, and/or the increment value. In some embodiments, other expressions may alternately or additionally be used in adjusting the transmission probability.

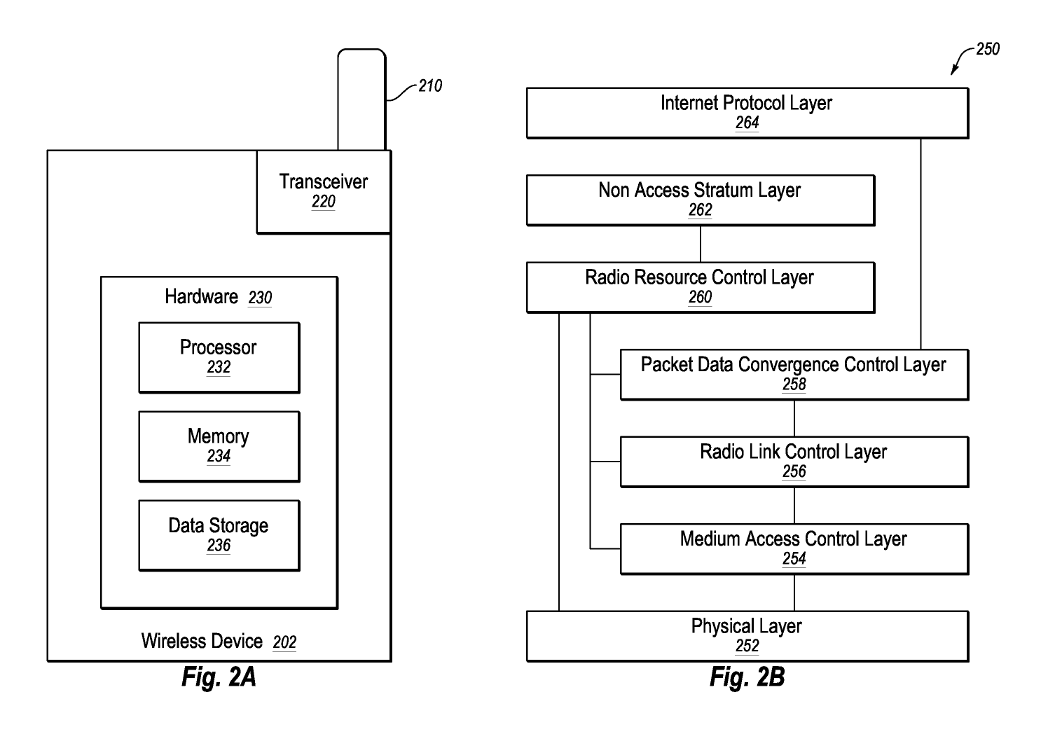

FIG. 2A is a diagram of an example wireless device 202. The wireless device 202 may generally correspond to the wireless devices 104 of FIG. 1. The wireless device 202 may include an antenna 210, a transceiver 220, and hardware 230. The hardware 230 may include an application-specific integrated circuit (ASIC), a Field-Programmable Gate Array (FPGA), or any other digital or analog circuitry configured to perform operations, such as the operations described as performed by the wireless devices 104 of FIG. 1. As illustrated in FIG. 2, the hardware 230 may include a processor 232, a memory 234, and data storage 236. In these and other embodiments, the processor 232, the memory 234, and the data storage 236 may be configured to perform some or all of the operations performed by the hardware 230. In other embodiments, the hardware 230 may not include one or more of the processor 232, the memory 234, and the data storage 236.

Generally, the processor 232 may include any suitable special-purpose or general-purpose computer, computing entity, or processing device including various computer hardware or software modules and may be configured to execute instructions stored on any applicable computer-readable storage media. For example, the processor 232 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 2A, the processor 232 may include any number of processors configured to perform individually or collectively any number of operations described herein. Additionally, one or more of the processors may be present on one or more different electronic devices. In some embodiments, the processor 232 may interpret and/or execute program instructions and/or process data stored in the memory 234, the data storage 236, or the memory 234 and the data storage 236. In some embodiments, the processor 232 may fetch program instructions from the data storage 236 and load the program instructions in the memory 234. After the program instructions are loaded into the memory 234, the processor 232 may execute the program instructions.

The memory 234 and data storage 236 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 232. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium that may be used to carry or store desired program code in the form of computer-executable instructions or data structures, which may be accessed by a general-purpose or special-purpose computer. Combinations of the above may also be included within the scope of computer-readable storage media. Computer-executable instructions may include, for example, instructions and data configured to cause the processor 232 to perform a certain operation or group of operations.

FIG. 2B is a diagram of an example layer configuration 250 that may be implemented on the wireless device 202. In some embodiments, the layer configuration 250 may include a physical layer 252, a medium access control layer 254, a radio link control layer 256, a packet data convergence control layer 258, a radio resource control layer 260, a non access stratum layer 262, and an internet protocol layer 264. The physical layer 252 may also be described as a layer 1. Alternately or additionally, the medium access control layer 254, the radio link control layer 256, and the packet data convergence control layer 258 may together be described as a layer 2. Alternately or additionally, the radio resource control layer 260, the non access stratum layer 262, and the internet protocol layer 264 may together be described as a layer 3. The medium access control layer 254, the radio link control layer 256, the packet data convergence control layer 258, the radio resource control layer 260, the non access stratum layer 262, and the internet protocol layer 264 may be described as higher layers relative to the physical layer 252. In some embodiments, more or fewer layers may be included in the layer configuration.

In some embodiments, the wireless device 202 may employ multiple layers of the layer configuration 250 in adjusting a transmission probability for transmitting D2D discovery messages. For example, the physical layer 252 may generate the values for the tuple {N0, N1, NC} and communicate the tuple {N0, N1, NC} to a higher layer. In turn, the higher layer may adjust the transmission probability based on the tuple {N0, N1, NC} and return the adjusted transmission probability to the physical layer 252. In some embodiments, the radio resource control layer 260 may adjust the transmission probability.

Referring again to FIG. 2A, the antenna 210 may be coupled to the transceiver 220. The antenna 210 may have any number of configurations. The antenna 210 may also be configured to transmit and receive wireless communication signals in a wireless communication network. In particular, the antenna 210 may be configured to transmit wireless communications between the wireless device 202 and an access point, and to transmit and receive D2D discovery signals. The antenna 210 may send the received wireless communication signals to the transceiver 220.

The antenna 210 may be further configured to receive wireless communication signals for transmission from the transceiver 220. The antenna 210 may transmit the wireless communication signals to other wireless devices.

The hardware 230 may be configured to perform operations based on the wireless communication signals. For example, in some embodiments, the hardware 230 may be configured to receive wireless communication signals from the transceiver 220 and to decode the wireless communication signals to extract data from the wireless communications signals. In some embodiments, the wireless communication signal may be a D2D discovery message. The hardware 230 may also extract information about a neighboring wireless device that transmitted the D2D discovery message. By extracting information about the neighboring wireless device, the wireless device 300 may discover its neighboring wireless device.

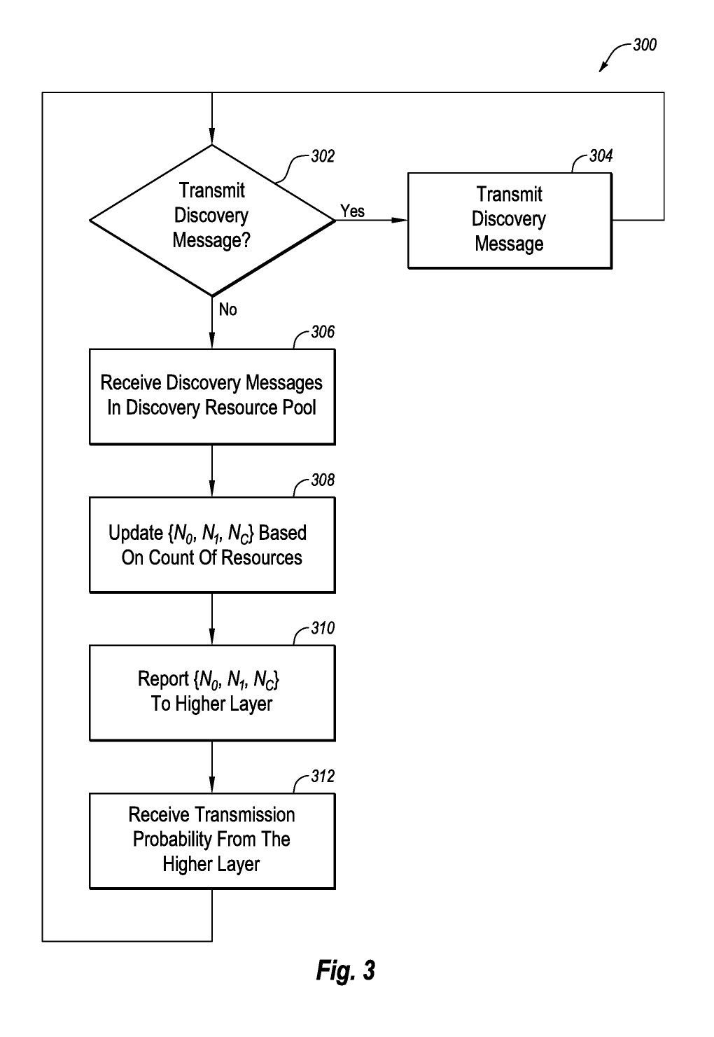

The hardware 230 may be configured to perform other operations that are described herein as performed by wireless devices. For example, the hardware 230 may be configured to perform the operations described as performed by the wireless devices 104 of FIG. 1, and/or the methods as described below with reference to FIGS. 3-5.

FIG. 3 is a flowchart of an example method 300 of transmitting D2D discovery messages and gathering information for adjusting a transmission probability for D2D discovery. In some embodiments, the method 300 may be performed at a physical layer of a device. For example, the method 300 may be performed, in whole or in part, at the physical layer 252 of the wireless device 202 of FIG. 2B. The transmission probability may be represented by the symbol p and may generally correspond to the transmission probability as described with reference to FIG. 1.

The method 300 may begin at block 302 by determining whether to transmit a D2D discovery message in a current discovery subframe associated with a D2D discovery resource pool. Determining whether to transmit the discovery message may be based on a request from a higher layer and/or the value of the transmission probability.

If a discovery message is to be transmitted during the current subframe, the method 300 may proceed to block 304 by transmitting the discovery message. If a discovery message is not to be transmitted during the current subframe, the method 300 may proceed to block 306 by receiving discovery messages via discovery resources. The method 300 may continue in block 308 by generating, for the discovery resource pool, values for the tuple {N0, N1, NC}, which may generally correspond to the tuple {N0, N1, NC} as described with reference to FIG. 1. In some embodiments, the values of N0, N1, and NC may be generated by assigning each of N0, N1, and NC an initial value of 0 and incrementing, by 1, N0 for each idle resource, N1 for each resource associated with successfully received discovery messages, and NC for each resource associated with discovery messages not successfully received.

The method 300 may continue in block 310 by reporting the tuple {N0, N1, NC} to a higher layer. In some embodiments, the tuple {N0, N1, NC} may be reported at the end of the discovery resource pool. The method 300 may continue in block 312 by receiving a transmission probability from the higher layer, which may be adjusted based on the reported tuple {N0, N1, NC}.

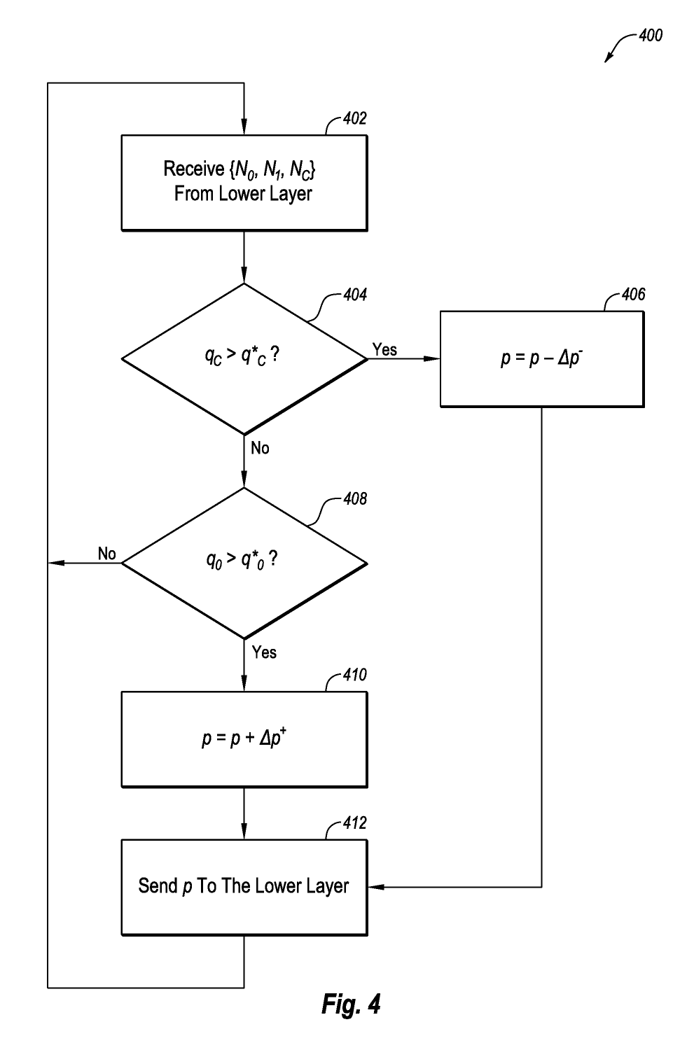

FIG. 4 is a flowchart of an example method 400 of adjusting a transmission probability based on a tuple {N0, N1, NC}. In some embodiments, the method 400 may be performed, in whole or in part, at a higher layer of a device. For example, the method 400 may be performed, in whole or in part, at the radio resource control layer 260 and/or another layer higher than the physical layer 252 of the wireless devices 202 of FIG. 2B. The tuple {N0, N1, NC} may respectively correspond to the tuple {N0, N1, NC} as described with reference to FIGS. 1-3. The transmission probability may be represented by the symbol p and may generally correspond to the transmission probability as described with reference to FIGS. 1-3. In some embodiments, the method 400 may be performed in conjunction with the method 300 of FIG. 3.

The method 400 may begin at block 402 by receiving the tuple {N0, N1, NC} from a lower layer, such as a physical layer generally corresponding to the physical layer 252 of FIG. 2B. The method 400 may continue at block 404 by determining whether a collision ratio is greater than a collision ratio threshold. The collision ratio may be represented by the symbol qC and may generally correspond to the collision ratio described with reference to FIG. 1. The collision ratio threshold may be represented by the symbol q*C and may generally correspond to the collision ratio threshold described with reference to FIG. 1. If the collision ratio is greater than the collision ratio threshold, the method 400 may proceed to block 406. If the collision ratio is not greater than the collision ration threshold, the method 400 may proceed to block 408.

At block 406, the transmission probability may be decremented by a decrement value. The decrement value may be represented by the symbol Δp− and may generally correspond to the decrement value described with reference to FIG. 1. From block 406, the method 400 may continue at block 412.

At block 408, the method 400 may determine whether an idle ratio is greater than an idle ratio threshold. The idle ratio may be represented by the symbol q0 and may generally correspond to the idle ratio described with reference to FIG. 1. The idle ratio threshold may be represented by the symbol q*0 and may generally correspond to the idle ratio threshold described with reference to FIG. 1.

If the idle ratio is greater than the idle ratio threshold at block 408, the method 400 may proceed to block 410. If the idle ratio is not greater than the idle ratio threshold at block 408, the method 400 may return to block 402. Thus, for example, if the collision ratio is not greater than the collision ratio threshold and the idle ratio is not greater than the idle ratio threshold, the transmission probability may not be changed.

At block 410, the transmission probability may be incremented by an increment value. The increment value may be represented by the symbol Δp+ and may generally correspond to the increment value described with reference to FIG. 1. From block 410, the method 400 may continue at block 412.

At block 412, the transmission probability may be sent to the lower layer. From block 412, the method 400 may proceed to block 402.

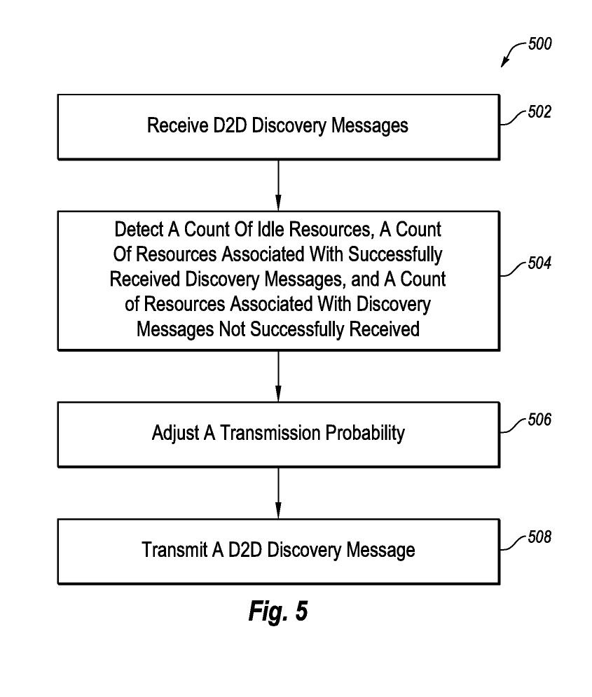

FIG. 5 is a flowchart of an example method 500 of adjusting a transmission probability for D2D out-of-network discovery. In some embodiments, the method 500 may be performed, in whole or in part, by a wireless device generally corresponding to the wireless devices 104 of FIG. 1 and/or the wireless device 202 of FIG. 2.

The method 500 may begin at block 502 by receiving D2D discovery messages. The discovery messages may be received outside of network coverage. Alternately or additionally, the discovery messages may be associated with a discovery resource pool.

The method 500 may continue at block 504 by detecting a count of idle resources, a count of resources associated with successfully received discovery messages, and a count of resources associated with discovery messages not successfully received. The counts may be associated with the discovery resource pool. Alternately or additionally, the counts may be associated with a tuple {N0, N1, NC} generally corresponding to the tuple {N0, N1, NC} described with reference to FIGS. 1-4.

The method 500 may continue at block 506 by adjusting a transmission probability. The transmission probability may generally correspond to the transmission probability described with reference to FIGS. 1-4. The transmission probability may be associated with the discovery resource pool. Alternately or additionally, the transmission probability may be adjusted based at least in part on the count of idle resources, the count of resources associated with successfully received discovery messages, and/or the count of resources associated with discovery messages not successfully received.

In some embodiments, adjusting the transmission probability may be based at least in part on the count of resources associated with the discovery messages not successfully received. Additionally, adjusting the transmission probability may include decreasing the transmission probability based at least in part on a ratio of the count of the resources associated with discovery messages not successfully received to a total of the count of idle resources, the count of resources associated with successfully received discovery messages, and the count of resources associated with discovery messages not successfully received.

Alternately or additionally, adjusting the transmission probability may be based at least in part on the count of idle resources. Additionally, adjusting the transmission probability may include increasing the transmission probability based at least in part on a ratio of the count of idle resources to a total of the count of idle resources, the count of resources associated with successfully received discovery messages, and the count of resources associated with discovery messages not successfully received.

The method 500 may continue at block 508 by transmitting a D2D discovery message. The discovery message may be transmitted via the discovery message pool. Alternately or additionally, transmission of the discovery message may be based at least in part on the transmission probability.

For this and other processes and methods disclosed herein, the functions performed in the processes and methods may be implemented in differing order. Furthermore, the outlined operations are provided only as examples, and some of the operations may be optional, combined into fewer operations, or expanded into additional operations without detracting from the essence of the embodiments.

For example, in some embodiments, the method 500 may further include updating the transmission probability via a radio resource control message from a base station in response to a device performing the method 500 moving into network coverage.

Alternately or additionally, the method 500 may further include initially basing the transmission probability on an in-network transmission probability received via a radio resource control message from a base station prior to the device moving outside of network coverage.

As indicated above, some embodiments described herein may include the use of a special purpose or general purpose computer (e.g., the processor 232 of FIG. 2A) including various computer hardware or software modules, as discussed in greater detail below. Further, as indicated above, embodiments described herein may be implemented using computer-readable media (e.g., the memory 234 of FIG. 2A) for carrying or having computer-executable instructions or data structures stored thereon.

As used herein, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of adjusting a transmission probability for device-to-device out-of-network discovery, the method comprising:
receiving, outside of network coverage, device-to-device discovery messages associated with a discovery resource pool;
detecting, for the discovery resource pool, a count of idle resources, a count of resources associated with successfully received discovery messages, and a count of resources associated with discovery messages not successfully received;
adjusting a transmission probability associated with the discovery resource pool based at least in part on one or more of the count of idle resources, the count of resources associated with successfully received discovery messages, and the count of resources associated with discovery messages not successfully received; and
transmitting, outside of network coverage, a device-to-device discovery message via the discovery resource pool based at least in part on the transmission probability.

2. The method of claim 1, wherein adjusting the transmission probability is based at least in part on the count of resources associated with the discovery messages not successfully received.

3. The method of claim 2, wherein adjusting the transmission probability includes decreasing the transmission probability based at least in part on a ratio of the count of the resources associated with discovery messages not successfully received to a total of the count of idle resources, the count of resources associated with successfully received discovery messages, and the count of resources associated with discovery messages not successfully received.

4. The method of claim 1, wherein adjusting the transmission probability is based at least in part on the count of idle resources.

5. The method of claim 4, wherein adjusting the transmission probability includes increasing the transmission probability based at least in part on a ratio of the count of idle resources to a total of the count of idle resources, the count of resources associated with successfully received discovery messages, and the count of resources associated with discovery messages not successfully received.

6. The method of claim 1, wherein the method further includes updating the transmission probability via a radio resource control message from a base station in response to a device performing the method moving into network coverage.

7. The method of claim 1, wherein the method further includes basing the transmission probability on an in-network transmission probability received via a radio resource control message from a base station prior to the device moving outside of network coverage.

8. A device comprising:
an antenna to transmit, outside of network coverage, a device-to-device discovery message via a discovery resource pool based at least in part on a transmission probability associated with the discovery resource pool, and to receive, outside of network coverage, device-to-device discovery messages via the discovery resource pool;
a first layer to detect, for the discovery resource pool, a count of idle resources, a count of resources associated with successfully received discovery messages, and a count of resources associated with discovery messages not successfully received; and
a second layer to:
receive, from the first layer, the count of idle resources, the count of resources associated with successfully received discovery messages, and the count of resources associated with discovery messages not successfully received, and
adjust the transmission probability based at least in part on one or more of the count of idle resources, the count of resources associated with successfully received discovery messages, and the count of resources associated with discovery messages not successfully received.

9. The device of claim 8, wherein adjustment of the transmission probability is based at least in part on the count of resources associated with the discovery messages not successfully received.

10. The device of claim 9, wherein adjustment of the transmission probability includes decrease of the transmission probability based at least in part on a ratio of the count of resources associated with discovery messages not successfully received to a total of the count of idle resources, the count of resources associated with successfully received discovery messages, and the count of resources associated with discovery messages not successfully received.

11. The device of claim 8, wherein adjustment of the transmission probability is based at least in part on the count of idle resources.

12. The device of claim 11, wherein adjustment of the transmission probability includes increase of the transmission probability based at least in part on a ratio of the count of idle resources to a total of the count of idle resources, the count of resources associated with successfully received discovery messages, and the count of resources associated with discovery messages not successfully received.

13. The device of claim 8, wherein the transmission probability is updated via a radio resource control message from a base station in response to the device moving into network coverage.

14. The device of claim 8, wherein the transmission probability is initially based on an in-network transmission probability received via a radio resource control message from a base station prior to the device moving outside of network coverage.

15. A non-transitory computer-readable medium having encoded therein programing code executable by a processor to perform operations comprising:
receiving, outside of network coverage, device-to-device discovery messages associated with a discovery resource pool;
detecting, for the discovery resource pool, a count of idle resources, a count of resources associated with successfully received discovery messages, and a count of resources associated with discovery messages not successfully received;
adjusting a transmission probability associated with the discovery resource pool based at least in part on one or more of the count of idle resources, and the count of resources associated with discovery messages not successfully received; and
transmitting, outside of network coverage, a device-to-device discovery message via the discovery resource pool based at least in part on the transmission probability.

16. The non-transitory computer-readable medium of claim 15, wherein adjusting the transmission probability is further based at least in part on the count of resources associated with successfully received discovery messages.

17. The non-transitory computer-readable medium of claim 15, wherein adjusting the transmission probability includes decreasing the transmission probability based at least in part on a ratio of the count of resources associated with discovery messages not successfully received to a total of the count of idle resources, the count of resources associated with successfully received discovery messages, and the count of resources associated with discovery messages not successfully received.

18. The non-transitory computer-readable medium of claim 15, wherein adjusting the transmission probability includes increasing the transmission probability based at least in part on a ratio of the count of idle resources to a total of the count of idle resources, the count of resources associated with successfully received discovery messages, and the count of resources associated with discovery messages not successfully received.

19. The non-transitory computer-readable medium of claim 15, wherein the transmission probability is updated via a radio resource control message from a base station in response to the device moving into network coverage.

20. The non-transitory computer-readable medium of claim 15, wherein the transmission probability is initially based on an in-network transmission probability received via a radio resource control message from a base station prior to the device moving outside of network coverage.
